(19) United States
(12) Patent Application Publication
(10) Pub. No.: US 2016/0370131 A1
(43) Pub. Date: Dec. 22, 2016

(54) HEAT EXCHANGER

(71) Applicant: BORGWARNER EMISSIONS SYSTEMS SPAIN, S.L.U., Vigo (ES)

(72) Inventors: Xoan Xosé HERMIDA DOMÍNGUEZ, Gondomar (ES); Pablo MARTÍNEZ, Vigo (ES); Rodolfo PRIETO DOMÍNGUEZ, Vigo (ES)

(21) Appl. No.: 15/186,021

(22) Filed: Jun. 17, 2016

(30) Foreign Application Priority Data
Jun. 18, 2015 (EP) 15382321.6

(51) Int. Cl. F28F 9/02; F02M 26/32; F28F 9/013; F28D 7/10; F28F 1/34

(52) U.S. Cl. CPC F28F 9/0226; F28D 7/103; F28F 1/34; F28F 9/0131; F02M 26/32; F28D 2021/008

(57) ABSTRACT

The present disclosure relates to a heat exchanger with a particular crimped joint configuration between the manifold and the main body of the heat exchanger. To achieve the joint, the manifold comprises cavities distributed close to its perimetral edge, i.e., the edge that is coupled to the main body. The main body has a stepped seat on which the manifold is supported. Around the seat, the main body has a segment externally surrounding the manifold, at least in a band adjacent to its perimetral edge. This perimetral band has slots defining strips located between the slot and the free edge such that the strips, which are plastically deformed towards the inside of the cavities of the shell, establish a joint with a very rigid and strong coupling force.

### CROSS-REFERENCE TO RELATED APPLICATION

This application claims the benefit of and priority to European patent application No. 15382321.6 filed on Jun. 18, 2015, the entire disclosure of which is incorporated by reference herein.

### TECHNICAL FIELD

The present disclosure is a heat exchanger, specifically a heat exchanger for EGR (Exhaust Gas Recirculation) systems mainly for reducing nitrogen oxide emission in internal combustion vehicles. The main application of this heat exchanger is to remove the heat from a hot gas, the recirculated gas, by a liquid coolant.

The disclosure herein is characterized by a particular crimped joint configuration between the manifold and the main body of the heat exchanger. To achieve the joint, the manifold comprises cavities distributed close to its perimetral edge, i.e., the edge that is coupled to the main body. The main body has a stepped seat on which the manifold is supported. Around the seat, the main body has a segment externally surrounding the manifold, at least in a band adjacent to its perimetral edge. This perimetral band has slots defining strips located between the slot and the free edge such that the strips, which are plastically deformed towards the inside of the cavities of the manifold, establish a joint with a very rigid and strong coupling force.

The particular configuration of this joint allows for very short manufacturing times compared to the joints known today and the manufacturing tooling is less expensive.

### BACKGROUND

One of the fields of the art that has experienced the most intense development is the field of heat exchangers for EGR systems. The temperature of the recirculated gas taken from the exhaust gas reaches very high values. All the parts located in the segment of the EGR system before the heat exchanger are subjected to high temperatures. Particularly, the heat exchanger responsible for reducing the temperature of the recirculated gas has a joint between the manifold where the hot gas enters, and the heat exchanger which requires a very rigid, strong and reliable joint.

One very reliable joint is the well-known joint based on the use of screws or bolts distributed around the perimeter around the area of the joint. The drawback of such joints is that the screw tightening operation requires the screw to be spaced from the body of the exchanger so that the tightening tool allows acting on the screw. The spacing of each screw with respect to the main body to be attached gives rise to bigger devices, hindering the packing capacity on the engine bay and raising the total weight of the device. Another drawback associated with this screwed solution is that the efficient manufacture of the exchanger requires one actuator for each screw in addition to other accessories such as tightening torque limiters. The price of each actuator is high, so the price of the tooling is as well, especially if there are many screws.

An alternative to screwed joints is the use of crimped configurations or configurations formed by crimping. A crimped joint is understood as that joint between two parts by one or more securing elements, arranged in one of the parts, which are plastically deformed to establish the securing of the other part.

There are joints formed by crimping between the main body of a heat exchanger and its manifold. In these joints formed by crimping, the manifold is supported on a seat of the main body of the heat exchanger with the intermediation of an elastically deformable gasket. The manifold has a perimetral rib cooperating with tabs of the main body. Once the manifold is placed on the seat formed by the elastically deformable gasket, the tabs of the main body plastically deform by tooling particularly configured for this purpose until getting the tab to be supported on the perimetral rib of the manifold such that both bodies, the manifold and the main body, are brought closer together. Bringing these two parts closer together gives rise to a compressive force on the elastically deformable gasket. Given that the tabs plastically deform, the joint is permanent.

One of the drawbacks of this joint is that the plastic deformation of the tabs always entails a certain degree of elastic deformation. When the tooling imposes a certain degree of deformation, when the tooling is removed the tab recovers certain deformation and acquires an intermediate shape between the original shape and the shape imposed by the tooling. Although this degree of elastic recovery is small, the result is that the compression value of the elastically deformable gasket has a level of uncertainty that is hard to calculate during design.

Additionally, the joint between both parts, the main body of the exchanger and the manifold, always has an elastically deformable gasket between both such that in the event of high stresses it enables modifying the relative position between both parts, jeopardizing air-tightness, especially if over time the elastically deformable gasket has experienced wear.

The present disclosure provides a joint having the manufacturing advantages that a joint formed by crimping provides, but without the drawbacks identified above, i.e., under design conditions it allows establishing the degree of compression between the main body of the heat exchanger and the manifold with very low uncertainty, and the resulting joint is very rigid, maintaining air-tightness.

### SUMMARY

The present disclosure is a heat exchanger, preferably a heat exchanger for cooling recirculated gas in an EGR system, in which the joint between the main body of the heat exchanger and the manifold is by a particular crimping configuration.

When the heat exchanger is applied to cool hot recirculated gas in an EGR system, using the crimped joint according to the disclosure herein between the main body of the exchanger and the inlet manifold into the exchanger has particular advantage because this is the joint that is subjected to a higher temperature, and even in these more demanding conditions the joint according to the disclosure herein is capable of securely maintaining the joint.

According to a first aspect of the disclosure herein, the present disclosure comprises the two parts to be attached to one another:
a main body in turn comprising a shell, wherein
   the shell houses one or more heat exchange tubes for the passage of a first fluid, particularly a gas to be cooled, where the heat exchange tubes extend between two opposite ends of the shell;
   the shell comprises a space between the inner face of the shell and the heat exchange tubes for the passage of a second fluid, particularly a coolant fluid; and
   wherein the main body, in at least one of the ends of the shell, comprises a baffle such that the heat exchange tubes are attached to the baffle through one of the ends thereof; and
a manifold in fluid communication with the inside of the heat exchange tubes attached to the baffle, this manifold being attached to the main body.

The main body is the body of the heat exchanger where the bundle of exchange tubes is located and therefore where thermal energy is transferred from the gas to be cooled to the liquid coolant. The gas passes through the inside of the tubes of the bundle of tubes and the liquid coolant circulates around the outside of the tubes of the bundle of tubes and limited by the shell. Both fluids are separated such that heat is transferred from the hot gas to the liquid coolant through the wall of the exchange tubes.

The preferred configuration of the heat exchanger is the configuration of a shell extending in the longitudinal direction determined by the bundle of heat exchange tubes housed therein. Although the disclosure herein requires the shell to have at one of its ends a baffle receiving one of the ends of each of the tubes of the bundle of tubes, the preferred configuration makes use of two baffles, one at each end of the shell and such that one baffle receives one end of the tubes of the bundle of tubes, and the other baffle, located on the opposite side of the shell, receives the opposite end of the tubes.

The inner space demarcated by the inner wall of the shell, the heat exchange surface established by the exchange tubes and the baffle or baffles, is the space where the liquid coolant circulates. This space has inlet and outlet ports for the circulation of the liquid coolant.

With respect to the gas to be cooled, the gas enters through a manifold, preferably the manifold to be attached by crimping to the main body of the exchanger, in order to access the inside of the heat exchange tubes. After the hot gas passes through the inside of the exchange tubes, giving off its heat, it exits into a second manifold which leads it to a conduit for later use. Although this second manifold has been identified as such, according to various embodiments it can be formed by parts of other components such as valves, giving rise to more compact configurations, for example.

The baffle to which some of the ends of the heat exchange tubes are attached and which is located on the side of the main body of the heat exchanger where the joint formed by crimping is established is one of the elements which establishes the separation between the space of the liquid coolant and the gas such that the gas that is in the manifold to be attached to the main body of the heat exchanger is in fluid communication with the inside of the tubes attached to the baffle.

The disclosure herein is additionally characterized in that:
the manifold comprises a perimetral edge and a plurality of cavities on its outer face distributed around the perimeter and spaced from the perimetral edge,
the main body is prolonged in a segment externally surrounding the manifold at least by a band adjacent to its perimetral edge wherein the main body comprises a stepping such that there is arranged a seat of the perimetral edge of the manifold on the stepping; and
the segment of the main body externally surrounding the manifold comprises, coinciding with two or more cavities of the manifold and in each of such cavities, a strip configured between the edge of the segment of the main body externally surrounding the manifold and a slot spaced from the edge such that, the strip, by plastic deformation, enters the cavity of the manifold such that the free edge of the strip established by the slot is supported on the surface of the cavity arranged closest to the perimetral edge of the manifold.

The main body has a step establishing the seat at the perimetral edge of the manifold. This seat establishes direct or indirect contact between the main body of the heat exchanger and the manifold. The manifold has one or more cavities distributed around its periphery serving as a support for the deformable element of the main body establishing the crimping according to the first aspect of the disclosure herein. The cavities are close to the perimetral edge of the manifold and spaced from it. In turn, the main body is prolonged according to a segment externally surrounding the manifold. The way in which it externally surrounds or goes around the manifold is by a band at least partially covering the perimetral edge of the manifold and particularly reaching the cavities of the manifold. If the band completely covers the perimetral edge of the manifold, rigidity is greater and the joint is also stronger.

The segment of the main body reaching the cavities has a strip. The strip is defined between the edge of the segment externally surrounding the manifold and a slot spaced from the edge. The preferred configuration of the segment of the main body externally surrounding the manifold is, at least where the cavity is located, in the form of a band where the slot is preferably straight and parallel to the free edge of the band.

The strip mainly extends in a perimetral direction and has two free edges, one which is the free edge of the perimetral band and the other one, which is located on the other side of the strip, defined by the slot. The slot can be made, for example, by die cutting and, as stated, gives rise to one of the free edges of the strip.

Before the joint is established, the strip passes externally around the cavity. The joint is established by applying pressure from the outside on the strip, preferably in the central portion thereof, producing permanent deformation which makes the strip plastically deform towards the inside of the cavity. The position of the slot must be such that the free edge of the strip it generates makes contact with the inner surface of the cavity, being supported thereon in order to withstand the compressive stresses of the joint. In other words, the joint maintains compression through the support of the strip, plastically deformed towards the inside of the cavity, through its free edge generated by the slot, on the inner surface of the cavity.

The normal direction of the inner surface of the cavity on which there is established the support of the plastically deformed strip is mainly oriented in the direction of compression between the main body of the exchanger and the manifold. If the seat between the main body of the exchanger and the manifold is contained in one plane, the normal direction of the inner surface of the cavity on which the plastically deformed strip is supported is mainly oriented in the direction perpendicular to the plane.

In this case, it is the to be “mainly” oriented in the perpendicular direction because according to a preferred embodiment of the disclosure herein, the normal direction of the inner surface of the cavity on which the strip is supported is inclined with respect to the longitudinal direction of the body of the exchanger, with a small angle, giving rise to a wedging in the support of the strip. The inclination gives rise to a surface of the cavity in the support area favoring the adjustment of the degree of compression in the joint. The greater the deformation of the strip, i.e., it is imposed that the strip must further enter the cavity, the greater the compressive force the strip applies.

Deformation of the strip is in the direction of entry into the cavity, whereas the supporting force of the strip on the inner surface of the cavity is in a direction that is essentially perpendicular to the direction in which deformation has taken place in order to achieve plastic deformation of the strip. The technical effect of this condition is that any elastic recovery of the strip when performing plastic deformation also takes place in a direction perpendicular to the direction of the joint, and therefore does not affect the compressive stress in the joint. Even if the surface where the support is established is inclined, the elastic recovery will have a very small component of its projection on the direction established by the compression in the joint, minimizing its effect.

It has been indicated throughout this description that the seat of the manifold configured by a step is in the main body of the heat exchanger, and the same with respect to the segment surrounding or going around the manifold. Nevertheless, both the seat configured by a step and the segment surrounding or going around the manifold provided in the main body can be located in specific parts of the main body.

Such parts are a first part where, according to a first embodiment, the seat is configured like a step and the segment it surrounds is the shell; and a second part where, according to a second embodiment, the seat is configured like a step and the segment it surrounds is the baffle receiving the ends of the bundle of tubes located on the side of the manifold where the joint is established. Given that this second embodiment has a more complex configuration, it is what will be used according to two configurations to explain the disclosure herein in detail.

The first embodiment can be carried out, for example, by defining the seat or stepping for the manifold by an inward bend in the shell, leaving an expansion at the end of the shell corresponding to the band partially covering the manifold and where the strips are deformable.

The second example, which will be described in further detail in reference to the drawings, has the advantage that the shell and the baffle can have different thicknesses. The shell has strength requirements different from those of the baffle and the joint. This configuration allows establishing the suitable thicknesses for each of the functions.

### BRIEF DESCRIPTION OF THE DRAWINGS

These and other features and advantages of the disclosure herein will be better understood based on the following detailed description of a preferred embodiment, given solely by way of illustrative and non-limiting example, in reference to the attached drawings.

FIG. 1A shows an outer perspective view of an embodiment of a heat exchanger according to the disclosure herein.

FIG. 1B shows the same device of FIG. 1A in an elevational view sectioned by the midplane parallel to the longitudinal direction determined by the bundle of tubes.

FIG. 1C shows a perspective view of a detail of the baffle according to any of the examples that will be shown below based on the joint with the manifold through the baffle.

FIG. 1D shows a section in the support region of the manifold on the seat defined by the baffle, as well as the specific manner in which the joint force is assured by crimping.

FIG. 2 shows an exploded perspective view of the same embodiment shown in FIGS. 1A and 1B wherein tightness is achieved with an elastically deformable gasket.

FIG. 3 shows a section of the same embodiment according to a plane parallel to the longitudinal direction determined by the exchange tubes and in a central position coinciding with two cavities where the joint formed by crimping is established. The drawing corresponds to the configuration of the strips before carrying out the deformation establishing the joint.

FIG. 4 shows the same section as in the preceding drawing wherein the strips have already been deformed to establish the joint between the main body of the heat exchanger and the manifold.

FIGS. 5 and 6 show a perspective view such as that of FIG. 1A, before and after performing deformation of the strips, where the manifold has been sectioned in half by a plane parallel to the longitudinal direction determined by the exchange tubes and in a central position coinciding with two cavities wherein the joint formed by crimping is established, where this section allows observing the inside of the manifold and details of the joint.

FIG. 7 shows an exploded perspective view of a second embodiment where tightness is achieved with a metal gasket initially allowing a pre-established degree of deformation but which, once that pre-established deformation has been surpassed, performs in a rigid manner.

FIG. 8 shows a section of the same second embodiment according to a plane parallel to the longitudinal direction determined by the exchange tubes and in a central position coinciding with two cavities wherein the joint formed by crimping is established. The drawing corresponds to the configuration of the strips before performing the deformation establishing the joint.

FIG. 9 shows the same section as in the preceding drawing, wherein the strips have already been deformed to establish the joint between the main body of the heat exchanger and the manifold.

FIGS. 10 and 11 show a perspective view of the second embodiment, before and after performing deformation of the strips, wherein the manifold has been sectioned in half by a plane parallel to the longitudinal direction determined by the exchange tubes and in a central position coinciding with two cavities where the joint formed by crimping is established, wherein this section allows observing the inside of the manifold and details of the joint.

### DETAILED DESCRIPTION

According to the first inventive aspect, the present disclosure relates to a device for heat exchange, wherein the main body of the heat exchanger and at least one of its manifolds are attached by a specific joint formed by crimping.

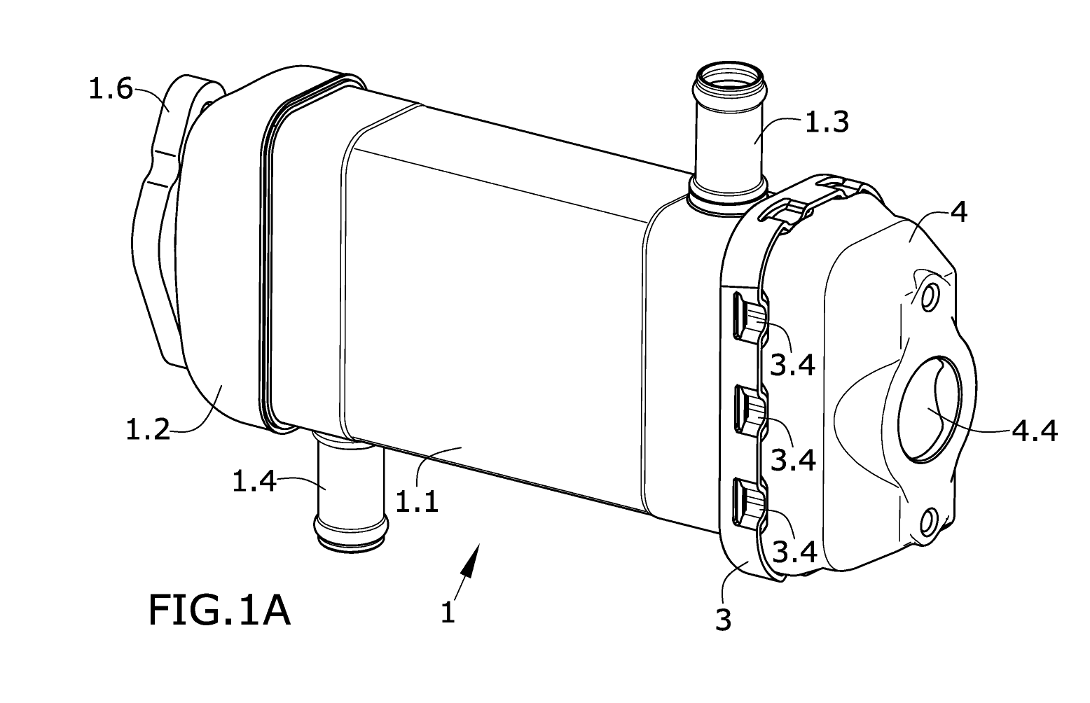

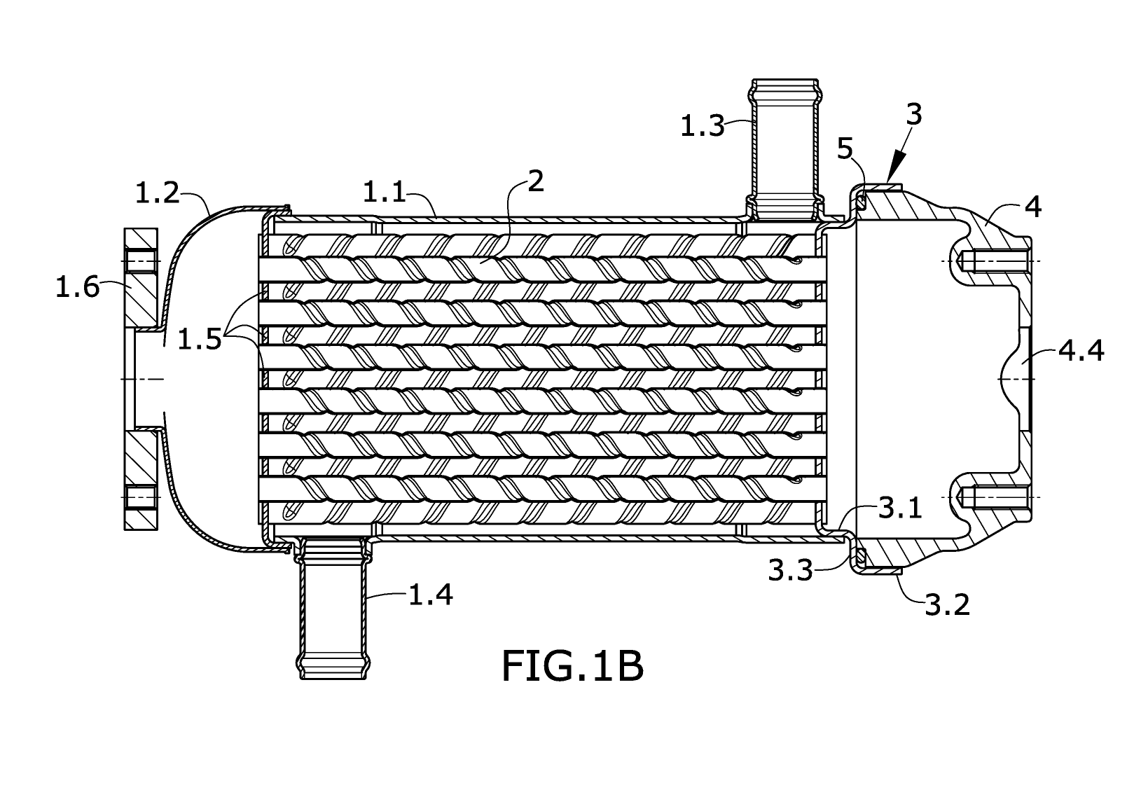

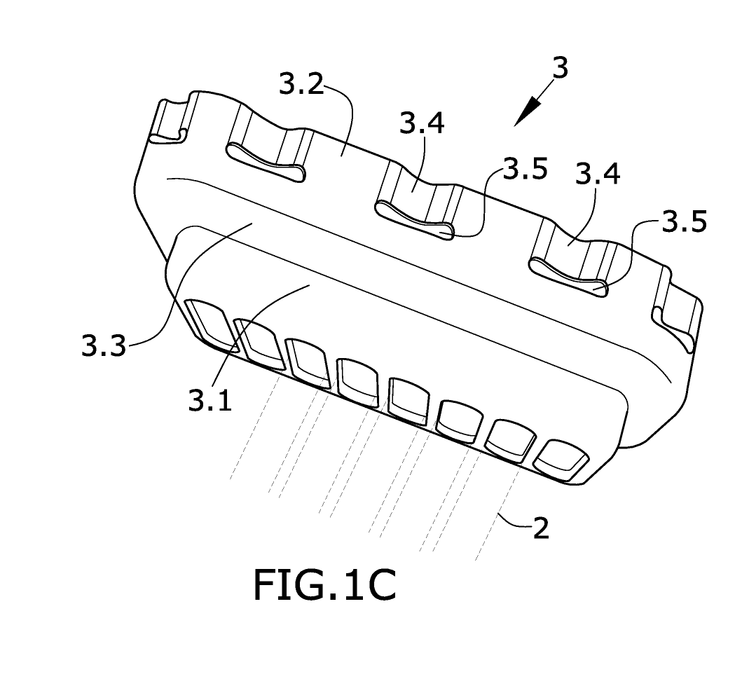

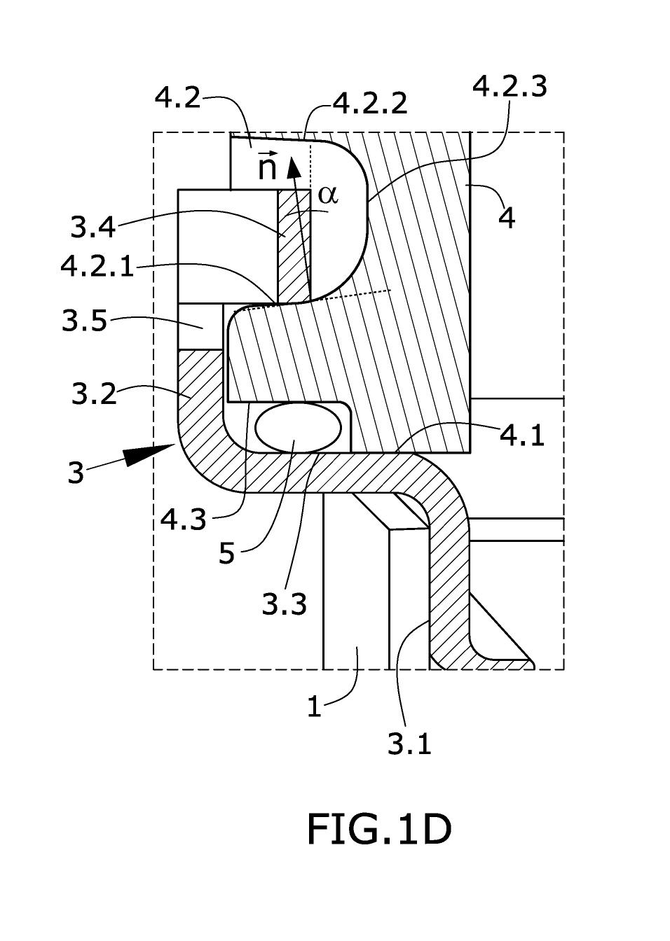

A first embodiment of the disclosure herein is seen in FIG. 1A by a perspective view of the heat exchanger. The heat exchanger of the embodiments that will be described is particularly suitable for cooling recirculated gas in an EGR system.

The heat exchanger according to this embodiment has a main body (1) comprising a shell (1.1) which is configured as a tubular element having a rectangular section.

FIG. 1B shows a section view of the heat exchanger, where a first baffle (3) is shown at one end of the shell (1.1) and a second baffle (1.5) is shown at the opposite end.

A bundle of heat exchange tubes (2) extending between the first baffle (3) and the second baffle (1.5) is housed inside the shell (1.1). The space left by the bundle of tubes (2) inside the shell (1.1) houses the liquid coolant circulating between an inlet and an outlet (1.3, 1.4) located at both ends of the shell (1.1).

Hot gas enters through an inlet (4.4) of a manifold (4) which is manufactured by molding in this embodiment. The inside of the manifold (4) is in fluid communication with the inside of the tubes of the bundle of tubes (2) such that the gas entering the manifold (4) passes to the interior of the bundle of tubes (2) to give off its heat. After getting past the bundle of tubes (2), the gas exits, reaching the inner space of an outlet manifold (1.2), manufactured in stamped sheet metal in this embodiment. As shown in FIG. 1B, the outlet manifold (1.2) has a flange (1.6) at its outlet which allows coupling to the already cooled EGR gas conduit.

Throughout this description, the part that is attached by crimping with the main body (1) has been identified as manifold (4) because this identification takes into consideration its function, which is to establish fluid communication of the gas it receives with the inside of the bundle of tubes (2); nevertheless, according to other embodiments the manifold can be the main body of a flow rate management valve or any other element verifying the same function and on which the joint is established according to the first inventive aspect.

An object of the disclosure herein is the joint between the manifold (4), in this case the intake manifold, and the main body (1) of the heat exchanger. In this embodiment, this joint is done by a configuration of the main body (1) provided by one of its components, the first baffle (3).

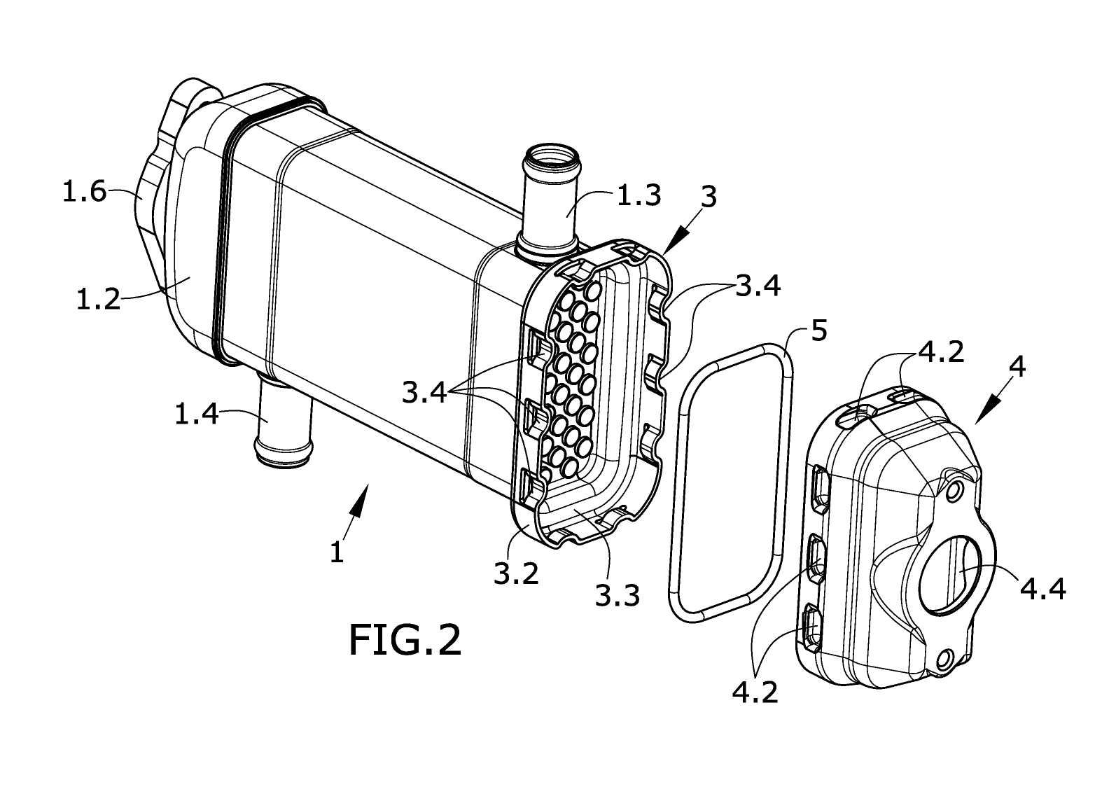

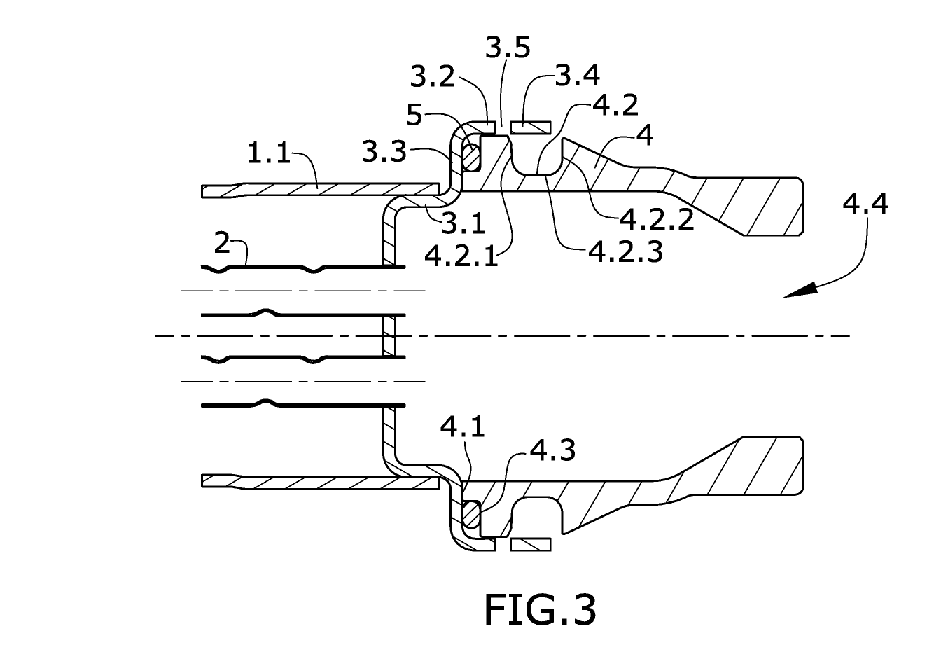

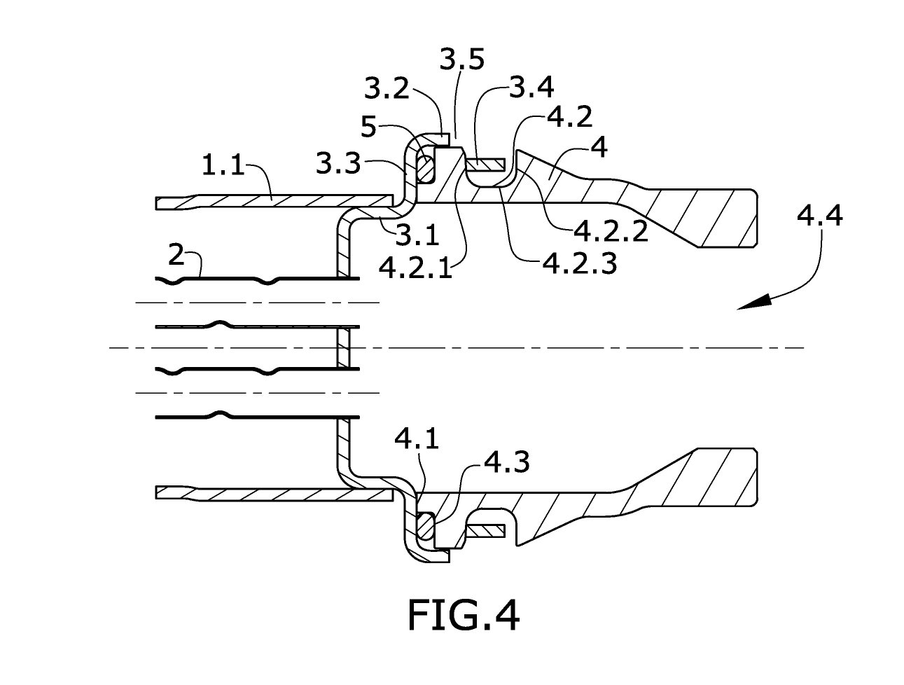

The first baffle (3), shown mainly in FIG. 1C and also in FIGS. 3 and 4 in section views and mounted in the exploded perspective view of FIG. 2, is a flat die cut and stamped plate. Perforations housing ends of the heat exchange tubes (2) are obtained by die cutting. These die cuts are on the essentially flat surface which is transverse to the heat exchange tubes (2).

This flat surface is prolonged according to two segments parallel to the surface of the shell (1.1), a first segment (3.1) arranged snugly against the inner face of the shell (1.1) and a second segment (3.2) having a larger section extending so as to surround the manifold (4) in an area in the form of band adjacent to the perimetral edge (4.1) of the manifold (4) being supported on the main body (1).

In section views, the first segment (3.1) and the second segment (3.2) are shown in FIGS. 3 and 4 as being straight and parallel, connected by stepping (3.3) providing a seat for the manifold (4).

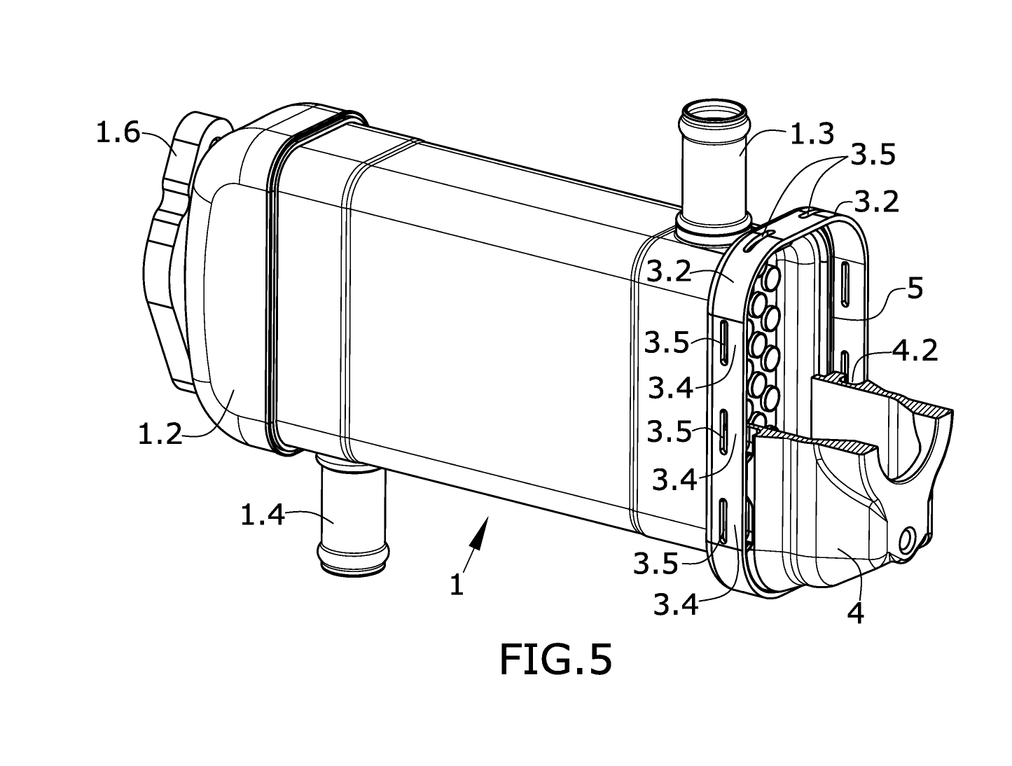

The section view of FIG. 3 and the perspective view of FIG. 5 show the configuration of the first baffle (3) before establishing the joint.

FIG. 2 shows the manifold (4) with a plurality of cavities (4.2) equally distributed in the peripheral area close to the perimetral edge (4.1), the one that establishes the seat on the main body (1), although spaced from same (4.1).

FIGS. 4 and 5, and mainly in the enlarged view of the joint shown in FIG. 1D, show how the perimetral edge (4.1) is supported directly on the seat formed by the stepping (3.3) of the first baffle (3). The outer face of the perimetral edge (4.1) establishing the support on the stepping (3.3) shows a step (4.3) generating a recessed space in the form of a housing for an elastically deformable perimetral gasket (5). In this embodiment, the elastically deformable perimetral gasket (5) is an elastic ring having a circular section.

Compression of the elastically deformable perimetral gasket (5) is due to the pressure applied by surfaces of two rigid parts, the surface of the step (4.3) of the manifold (4) and the surface of the stepping (3.3) serving as a seat for the manifold (4). Given that the distance between these two surfaces (4.3, 3.3) is less than the dimensions of the perimetral gasket (5), the gasket (5) is subjected to compression. Since the perimetral edge (4.1) of the manifold is supported directly on the seat, the condition concerning the distance between the step (4.3) and the perimetral edge (4.1) of the manifold (4) results in an equivalent condition concerning the distance between the surfaces (4.3, 3.3) pressing against the elastically deformable perimetral gasket (5).

The perimetral edge (4.1) of the manifold (4) is supported directly on the stepping (3.3), the distance between the step (4.3) and the perimetral edge (4.1) of the manifold (4) thereby does not depend on the degree of pressure between the manifold (4) and the main body (1) but rather on the dimensions of the step (4.3) of the manifold (4). The tolerances of this step (4.3) can be very precisely controlled during machining thereof, so the pressure on the perimetral gasket (5) or O-ring can be established without the gasket (5) sustaining significant variations derived from the production process.

In this embodiment it can be seen how the cavity (4.2) of the manifold (4) has two essentially parallel side walls (4.2.1, 4.2.2) and a wall at the bottom (4.2.3) of the cavity (4.2) transverse to the walls, all of them attached by curved transition surfaces.

The side wall (4.2.1) of the cavity (4.2) serving as a support in the joint, i.e., the wall closest to the perimetral edge (4.1) of the manifold (4) seated in the stepping (3.3) of the first baffle (3), is important.

The section views of FIGS. 3 and 4 and the perspective view of FIG. 2 show the second segment (3.2) of the baffle (3) with a set of slots (3.5) giving rise to strips (3.4). The slots (3.5) are oriented parallel to the free edge of the second segment (3.2) of the first baffle (3), giving rise to strips (3.4) defined between two parallel free edges, the free edge of the second segment (3.2) of the baffle (3) and the edge generated by the slot (3.5), for example by die cutting.

Before deformation, the strips (3.4) are flat segments which are located covering the cavity (4.2) with which they cooperate to establish the joint. The joint is established by pressing the strip (3.4) towards the inside of the cavity (4.2), giving rise to permanent deformation.

FIG. 1C shows in detail the baffle (3) with the deformed strips (3.4), where the deformed surface of the strip (3.4) is still parallel to the longitudinal direction in which the bundle of tubes (2) extends. This direction is the direction of compression of the joint and it is in the direction in which the strips (3.4) are capable of absorbing enormous stress. Likewise, this direction is a direction perpendicular to the direction in which both deformation of the strip and any possible elastic recovery, minimizing the effect thereof, takes place.

The joint between the baffle (3) and the shell (1.1) is preferably by brazing.

FIGS. 3 and 5 show the second segment (3.2) of the first flat baffle (3) with the slots (3.5), and FIGS. 2, 4 and 6 show the same second segment (3.2) with the resulting configuration after generating permanent deformations giving rise to the joint formed by crimping.

Particularly, FIG. 4 shows the final position of the central portion of the strip (3.4) after deformation, establishing the support through the free edge generated by the slot (3.5) on the surface (4.2.1) of the cavity arranged closest to the perimetral edge (4.1) of the manifold (4). In this particular case, the surface (4.2.1) of the cavity (4.2) arranged closest to the perimetral edge (4.1) of the manifold (4) is the side wall closest to the perimetral edge (4.1) of the manifold (4).

In this embodiment, the side wall (4.2.1) closest to the perimetral edge (4.1) of the manifold (4) shows a slight inclination (a) such that the cavity (4.2) is slightly more open at the inlet than at the bottom of the cavity (4.2). FIG. 1D shows the normal direction (\vec{η}) of the side wall (4.2.1) serving as a support surface of the strip (3.4) with an inclination of an angle α with respect to the longitudinal direction of the heat exchanger. This angle is also seen in the tangent plotted on the curve defined by the section of the side wall (4.2.1) at the support point of the strip (3.4) and which is shown by a dotted line.

This inclination (α) establishes a degree of wedging that increases the pressure force of the manifold (4) against the first baffle (3) through the seat formed by the stepping (3.3) the greater the deformation of the strip (3.4) towards the wall of the bottom (4.2.3) of the cavity (4.2).

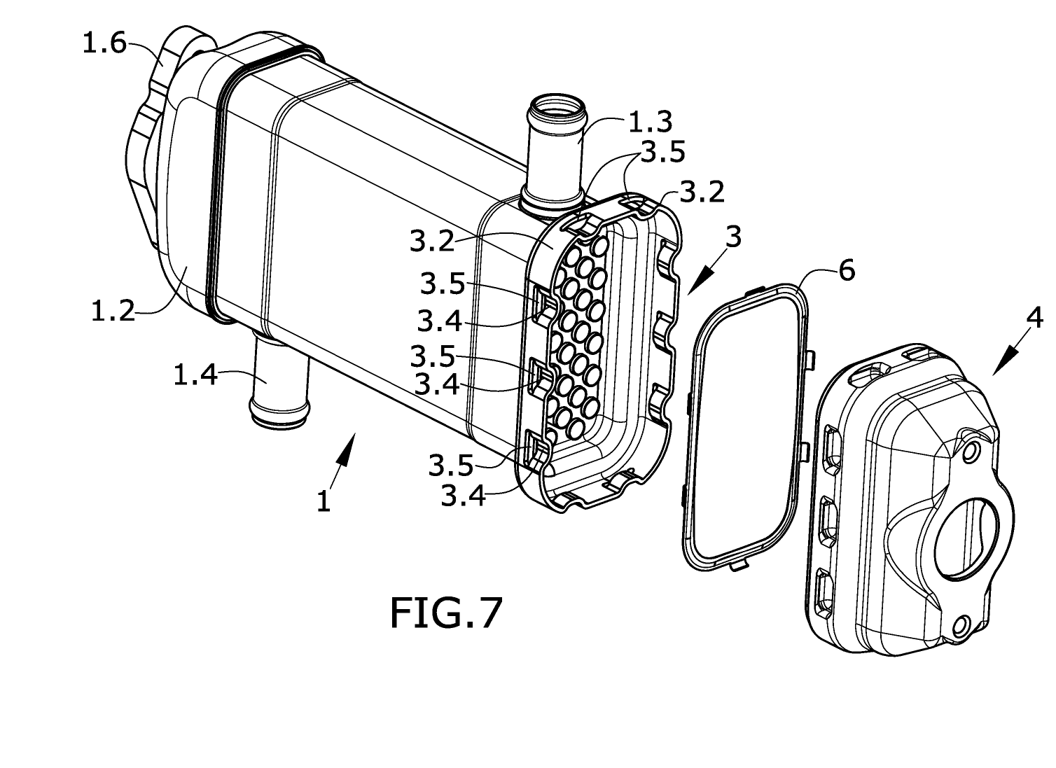

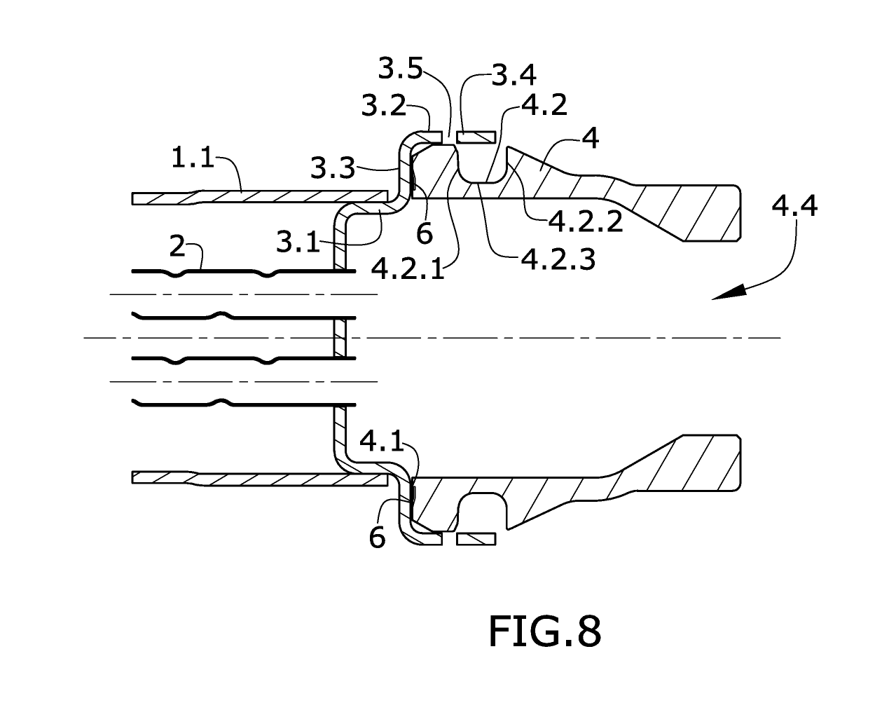

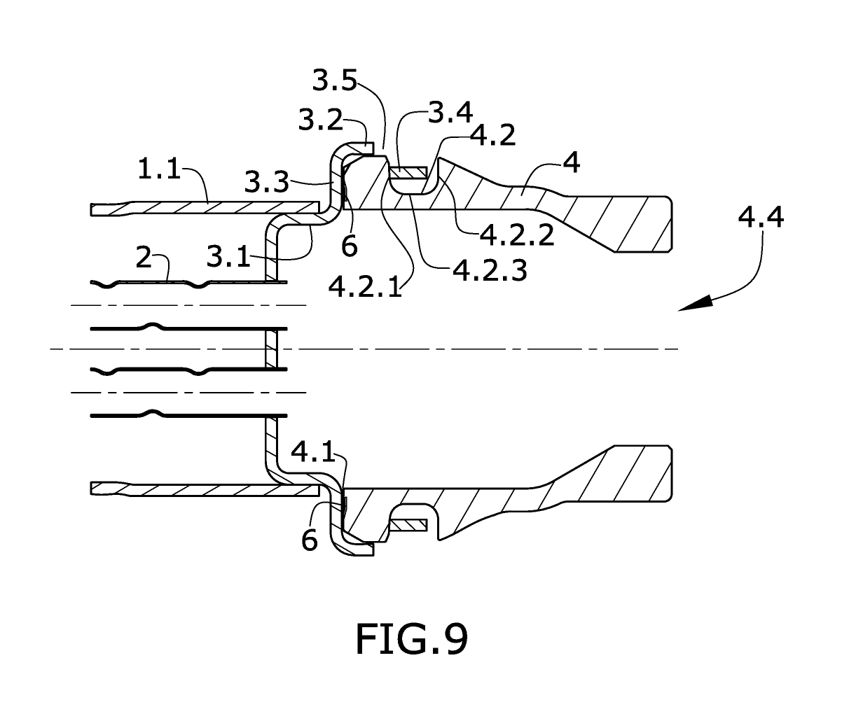

FIGS. 7 through 11 show a second embodiment with the same components as in the first embodiment except for those components directly linked with tightness between the manifold (4) and the main body (1). Therefore, the description of all the common elements is valid and for the sake of efficiency, only those changes in configuration related to the alternative solution for tightness are described below.

FIG. 7 shows an exploded view of the manifold (4) with respect to the main body (1) of the heat exchanger. In this perspective view, it can be seen that the elastically deformable gasket (5) of the first embodiment has been replaced with a metal gasket (6). In this case, the manifold (4) does not have a stepping (4.3) for housing the gasket but rather the metal gasket (6) is placed such that it is interposed between the stepping (3.3) of the baffle (3) acting as a seat and the free edge (4.1) of the manifold (4).

The metal gasket (6) has a discontinuous section such that when it is trapped between two parallel surfaces compressing it, it deforms until achieving a flat configuration. In this flat configuration, the metal gasket (6) no longer yields and starts to perform like a rigid solid. The metal gasket (6) thus configured requires a high attachment pressure. Nevertheless, it has been verified that the crimped joint according to the disclosure herein provides enough force, assuring proper air-tightness and dimensional stability.

The metal gasket (6) thus configured is identified in this description as a gasket having limited compression given that, after compressing the gasket, causing deformation sufficient for achieving the flat configuration between the surfaces compressing it, the gasket does not further deform. In this configuration, the separation between the surfaces compressing the metal gasket (6) is essentially the thickness of the plate with which the metal gasket (6) has been configured. The condition of being a gasket having limited compression means that once this element (6) is compressed, it performs like a rigid solid, and therefore the support between the manifold (4) and the stepping (3.3) maintains the same dimensional stability with respect to the direct contact used in the first embodiment.

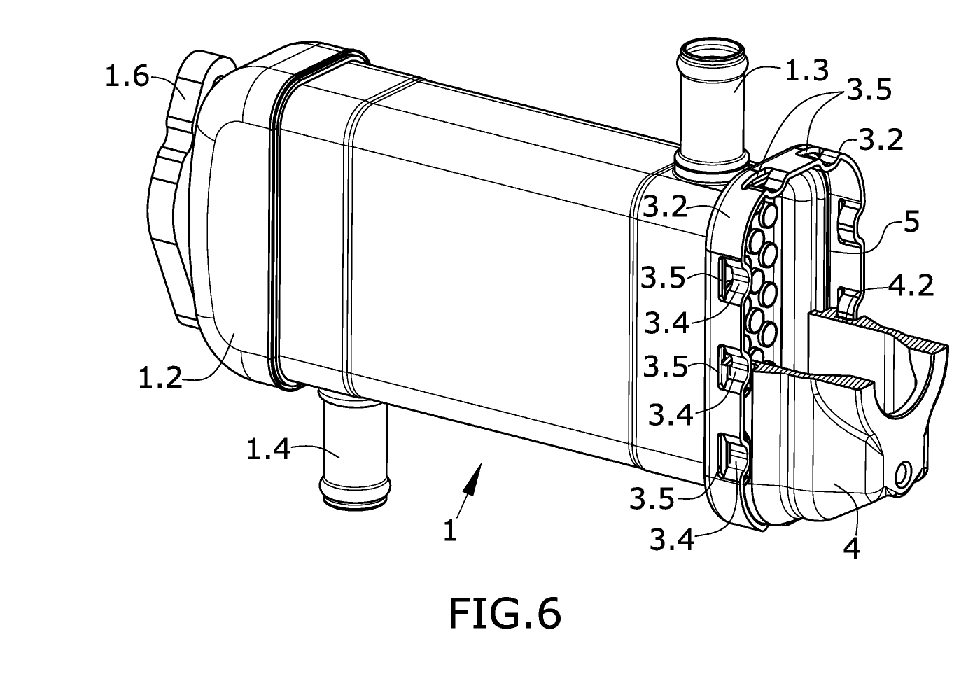

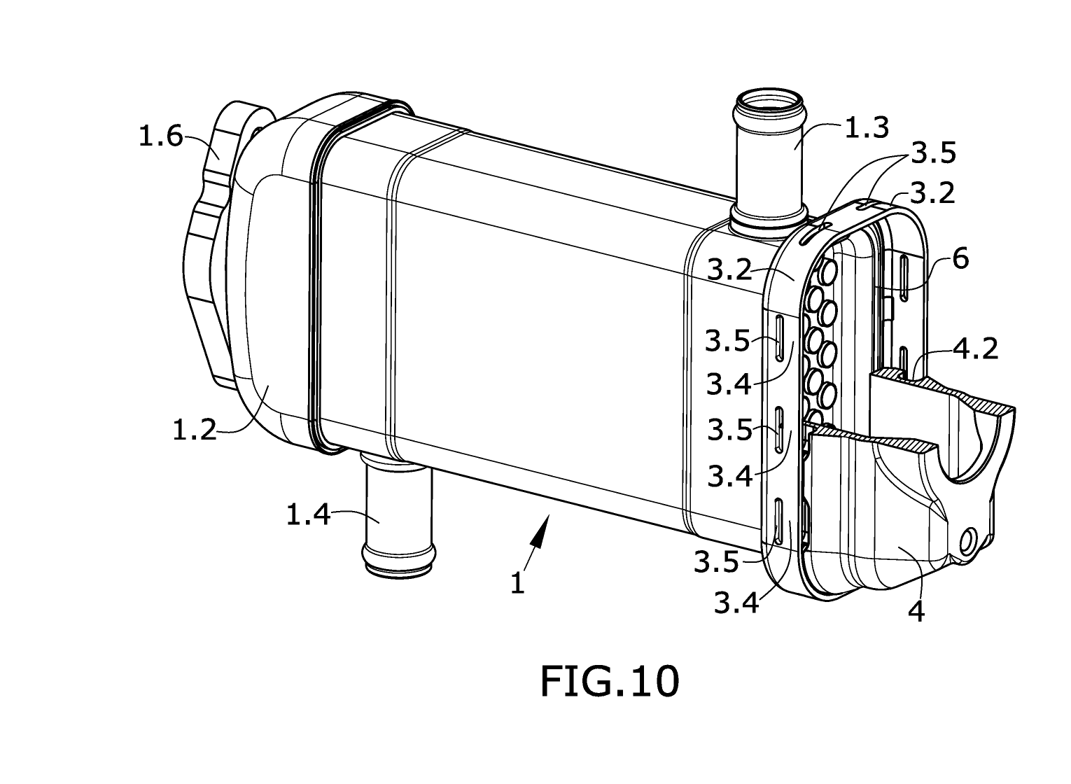

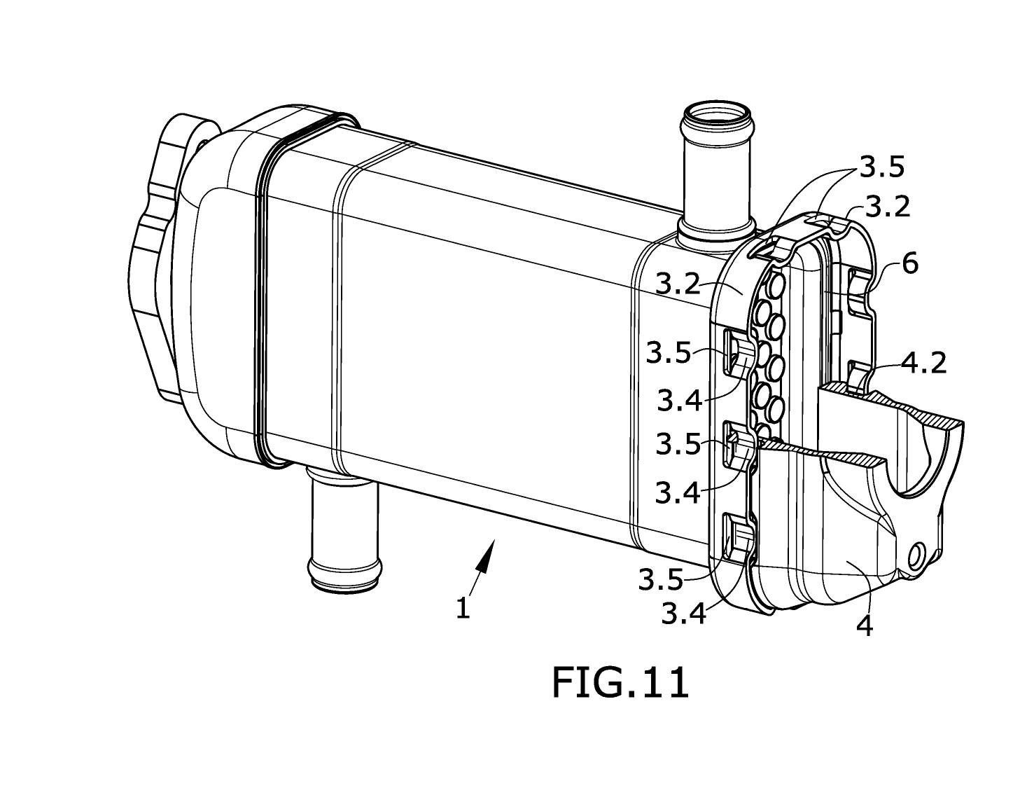

FIGS. 10 and 11 show the process of attachment by deformation of the strips inside the cavities (4.2) in a way that is equivalent to the process shown in FIGS. 5 and 6 for the first embodiment.

A preferred configuration establishes an equally distributed separation of the cavities (4.2) at least along the segments of each side of the prismatic configuration of the perimetral area along which the joint is established.

In any of the embodiments, the deformable strips (3.4) located in the segment (3.2) externally surrounding the manifold (4) at least by a band adjacent to its perimetral edge (4.1) can be configured such that they are stronger with a wider band such that the deformable strips (3.4) have a second, non-deformed strip adjacent to the deformable strip (3.4). The deformable strips (3.4) have been referred to as such because they are what are deformed after joint. After the joint they are deformed strips (3.4).

One way of obtaining this second, non-deformed adjacent strip is by applying two slots parallel to one another and parallel to the free edge of the second segment (3.2), a first slot (3.5) for generating the free support edge with the inner surface (4.2.1) of the cavity (4.2) and a second slot to establish the separation between the deformable strip (3.4) and the non-deformed strip.

This reinforced configuration obtained by two parallel slots is also applicable when the shell (1.1) of the main body (1) is what defines a seating step for the manifold (4) and the strips which allow the crimped joint with the manifold (4).

Another object of the disclosure herein is the EGR system having a more compact and lighter configuration incorporating a heat exchanger configured according to any of the examples described.

1. A heat exchanger comprising:
a main body in turn comprising a shell, wherein
the shell houses one or more heat exchange tubes for passage of a first fluid, particularly a gas to be cooled, where heat exchange tubes extend between two opposite ends of the shell;
the shell comprising a space between an inner face of the shell and the heat exchange tubes for passage of a second fluid, particularly a coolant fluid; and
wherein the main body, in at least one of the ends of the shell, comprises a baffle such that the heat exchange tubes are attached to the baffle through one of the ends thereof, and
a manifold in fluid communication with an inside of the heat exchange tubes attached to the baffle, this manifold being attached to the main body,
wherein:
the manifold comprises a perimetral edge and a plurality of cavities on its outer face distributed around the perimeter and spaced from the perimetral edge,
the main body is prolonged in a segment externally surrounding the manifold at least by a band adjacent to its perimetral edge wherein the main body comprises a stepping such that there is arranged a seat of the perimetral edge of the manifold on the stepping; and
the segment of the main body externally surrounding the manifold comprises, coinciding with two or more cavities of the manifold and in each of such cavities, a strip configured between the edge of the segment of the main body externally surrounding the manifold and a slot spaced from the edge such that by plastic deformation, the strip enters the cavity of the manifold such that the free edge of the strip established by the slot is supported on the surface of the cavity arranged closest to the perimetral edge of the manifold.

2. The heat exchanger according to claim 1, wherein the baffle of the main body extends, around the perimeter thereof, towards the manifold according to two consecutive segments:
a first segment of the baffle being supported on the inner face of either the shell or of the main body, and a second segment of the baffle giving rise to the segment of the main body externally surrounding the manifold, extending at least by a band adjacent to its perimetral edge; and wherein, and
between the first segment and the second segment, the baffle comprises a transition configured according to stepping, this stepping being the stepping of the main body establishing support for the perimetral edge of the manifold.

3. The heat exchanger according to claim 1, wherein the surface of the cavity of the manifold on which the strip is supported is inclined such that the greater the deformation of the strip towards the inside of the cavity, the greater the compression between the manifold and the baffle.

4. The heat exchanger according to claim 1, wherein
the perimetral edge of the manifold is supported directly on the stepping; and
the perimetral edge of the manifold has a step giving rise to a housing which houses an elastically deformable perimetral gasket, where the distance between the step and the perimetral edge of the manifold is less than the dimensions of the perimetral gasket.

5. The heat exchanger according to claim 1, wherein the perimetral edge of the manifold is supported on the stepping with the interposition of a metal gasket having limited compression, such that after a predetermined compression value the metal gasket performs like a rigid gasket.

6. The heat exchanger according to claim 5, wherein the metal gasket having limited compression has a discontinuous and/or stepped section.

7. The heat exchanger according to claim 1, wherein the cavities of the manifold are equally distributed around the perimetral edge of the manifold.

8. The heat exchanger according to claim 1, wherein the baffle is made of die-cut and stamped sheet metal.

9. The heat exchanger according to claim 1, wherein the joint between the baffle and either the shell or the main body, is by brazing.

10. An EGR system comprising a heat exchanger according to claim 1.
